(19) United States
(12) Patent Application Publication
(10) Pub. No.: US 2014/0239882 A1
(43) Pub. Date: Aug. 28, 2014

(54) APPARATUS FOR CHARGING BATTERY THROUGH PROGRAMMABLE POWER ADAPTER

(71) Applicant: SYSTEM GENERAL CORPORATION, New Taipei City (TW)

(72) Inventor: Ta-Yung YANG, Milpitas, CA (US)

(73) Assignee: SYSTEM GENERAL CORPORATION, New Taipei City (TW)

(21) Appl. No.: 14/094,909

(22) Filed: Dec. 3, 2013

Related U.S. Application Data
(60) Provisional application No. 61/769,228, filed on Feb. 26, 2013.

(51) Int. Cl. H02J 7/00

(52) U.S. Cl. CPC H02J 7/0052
USPC 320/107

(57) ABSTRACT

An apparatus for charging a battery is provided and includes a power adaptor and a controller. The power adaptor has a communication interface coupled to a cable of the power adapter for receiving command-data and generates a DC voltage and a DC current according to the command-data. The controller is coupled to the battery for detecting a battery voltage of the battery and generates the command-data according to the battery voltage. The DC voltage and the DC current are coupled to the cable and programmable according to the command-data. The command-data is coupled the cable through a communication circuit of the controller.

### CROSS REFERENCE TO RELATED APPLICATIONS

This application claims the benefit of U.S. Provisional Application No. 61/769,228, filed on Feb. 26, 2013, the contents of which are incorporated herein by reference.

### BACKGROUND OF THE INVENTION

1. Field of the Invention

The invention relates an apparatus for charging a battery by using a programmable power adapter.

2. Description of the Related Art

A traditional approach has a programmable DC/DC converter (such as a buck converter or a buck/boost converter) equipped close to a battery for charging the battery. The input of this programmable DC/DC converter is coupled to the output of a power adapter with a constant current and/or constant voltage. The drawback of the traditional approach is low efficiency. The buck converter or the buck/boost converter will cause further power loss.

### BRIEF SUMMARY OF THE INVENTION

The present invention is provided to eliminate the need of a DC/DC converter and improve the efficiency for battery charge.

An exemplary embodiment of an apparatus for charging a battery is provided. The apparatus comprises a power adaptor and a controller. The power adaptor has a communication interface coupled to a cable of the power adapter for receiving command-data. The power adaptor generates a DC voltage and a DC current in accordance with the command-data. The controller is coupled to the battery for detecting a battery voltage of the battery. The controller generates the command-data in accordance with the battery voltage. The DC voltage and the DC current generated by the power adaptor are coupled to the cable, and the DC voltage and the DC current are programmable in accordance with the command-data. The command-data generated by the controller is coupled the cable through a communication circuit of the controller.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows an exemplary embodiment of a charging apparatus;.

FIG. 2 shows an exemplary embodiment of a controller of the charging apparatus in FIG. 1;

FIG. 3 shows an exemplary embodiment of a control circuit of the charging apparatus in FIG. 1;

FIG. 4 shows an exemplary embodiment of a programmable power supply circuit of the charging apparatus in FIG. 1;

FIG. 5 shows an exemplary embodiment of a switching controller of the programmable power supply circuit in FIG. 4;

FIG. 6 shows an exemplary embodiment of a switching control circuit of the programmable power supply circuit in FIG. 4; and

FIG. 7 shows an exemplary embodiment of a feedback circuit of the switching control circuit in FIG. 6.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

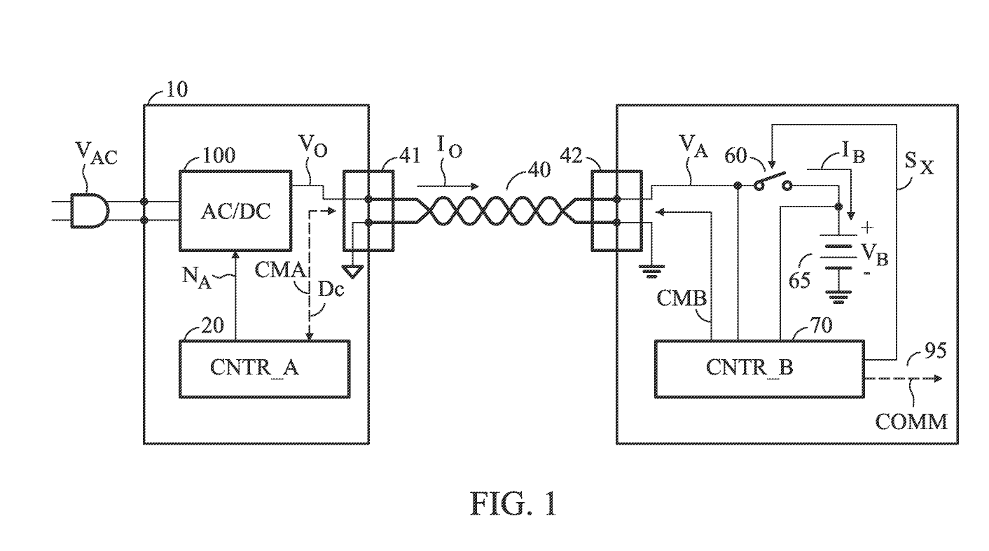

FIG. 1 shows a communication interface CMA coupled to a cable 40 through a connector 41 for receiving command-data Dc and generating an output voltage V_{O} and an output current I_{O} in accordance with the command-data Dc. The cable 40 is the output cable of a power adapter 10. The output voltage V_{O} and the output current I_{O} generated by the power adaptor 10 are delivered to the cable 40. A controller (CNTR_B) 70 is coupled to a battery 65 to detect a battery-voltage V_{B} of the battery 65 for generating the command-data Dc in accordance with the battery-voltage V_{B}. An terminal of a switch 60 is coupled to the cable 40 for receiving the output voltage V_{O} and the output current I_{O} through a connector 42. Another terminal of the switch 60 is coupled to the battery 65 for charging the battery 65. The output voltage V_{O} and the output current I_{O} are programmable in accordance with the command-data Dc. The command-data Dc generated by the controller 70 is coupled to the cable 40 through a communication interface CMB of the controller 70. The controller 70 is coupled the connector 42 to detect a connector-voltage V_{A}. The controller 70 generates a control signal S_{X} in response to the connector-voltage V_{A}. The control signal S_{X} is coupled to control the on/off state of the switch 60. The switch 60 will be turned off if the voltage drop of the cable 40 and the connector 42 is high. The controller 70 further has a communication port (COMM) 95 coupled to a host CPU (not shown), such as a CPU of a mobile-phone or a CPU of a notebook/PC, etc.

The power adapter 10 comprises an input terminal coupled to an AC power source (line voltage input) V_{AC} for generating a DC voltage of the output voltage V_{O} and a DC current of the output current I_{O}. The power adapter 10 further comprises a programmable power supply circuit (AC/DC) 100 for generating the output voltage V_{O} and the output current I_{O} in accordance with the control of a control circuit (CNTR_A) 20. The control circuit 20 is coupled to the cable 40 via the communication interface CMA for receiving and sending the command-data Dc. The control circuit 20 generates a data-bus signal N_{A} coupled to control the programmable power supply circuit 100. One example for the approach of the communication interface CMA and CMB can be found in a prior art of U.S. Pat. No. 8,154,153 titled “Method and apparatus for providing a communication channel through an output cable of a power supply”.

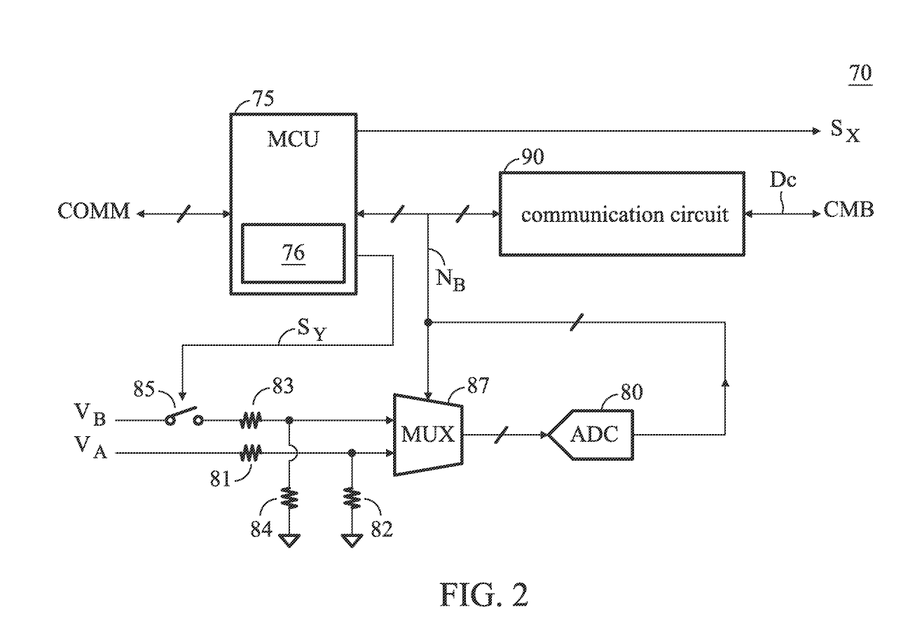

FIG. 2 shows an exemplary embodiment of the controller 70 in accordance with the present invention. The controller 70 includes an analog-to-digital converter (ADC) 80 coupled to the battery 65 (shown in FIG. 1) through a multiplexer (MUX) 87, resistors 83 and 84, and a switch 85 for detecting the battery-voltage V_{B}. The analog-to-digital converter 80 is further coupled to the connector 42 (shown in FIG. 1) via the multiplexer 87 and resistors 81 and 82 for detecting the connector-voltage V_{A}. A microcontroller (MCU) 75 comprises a memory 76. The memory 76 comprises a program memory and a data memory. The microcontroller 75 generates a control signal S_{Y} coupled to control the on/off state of the switch 85. The microcontroller 75 generates the control signal S_{X} coupled to control the on/off state of the switch 60. The microcontroller 75 further generates a data-bus signal N_{B} coupled to control the multiplexer 87, reads the data from the analog-to-digital converter 80, and reads/writes the command-data Dc through a communication circuit 90 and the communication interface CMB.

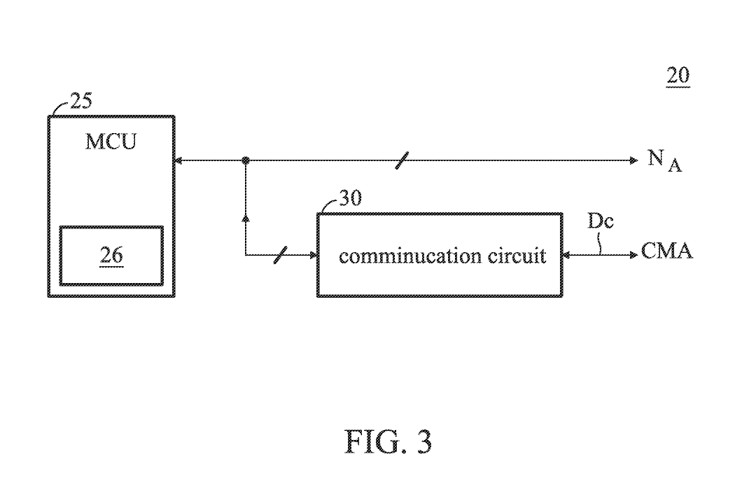

FIG. 3 shows an exemplary embodiment of the control circuit 20 in accordance with the present invention. The control circuit 20 comprises a microcontroller (MCU) 25. The microcontroller 25 comprises a memory 26, and the memory 26 comprises a program memory and a data memory. The microcontroller 25 generates the data-bus signal N_{A}. The data-bus signal N_{A} is coupled to read/write the command-data Dc through a communication circuit 30 and the communication interface CMA.

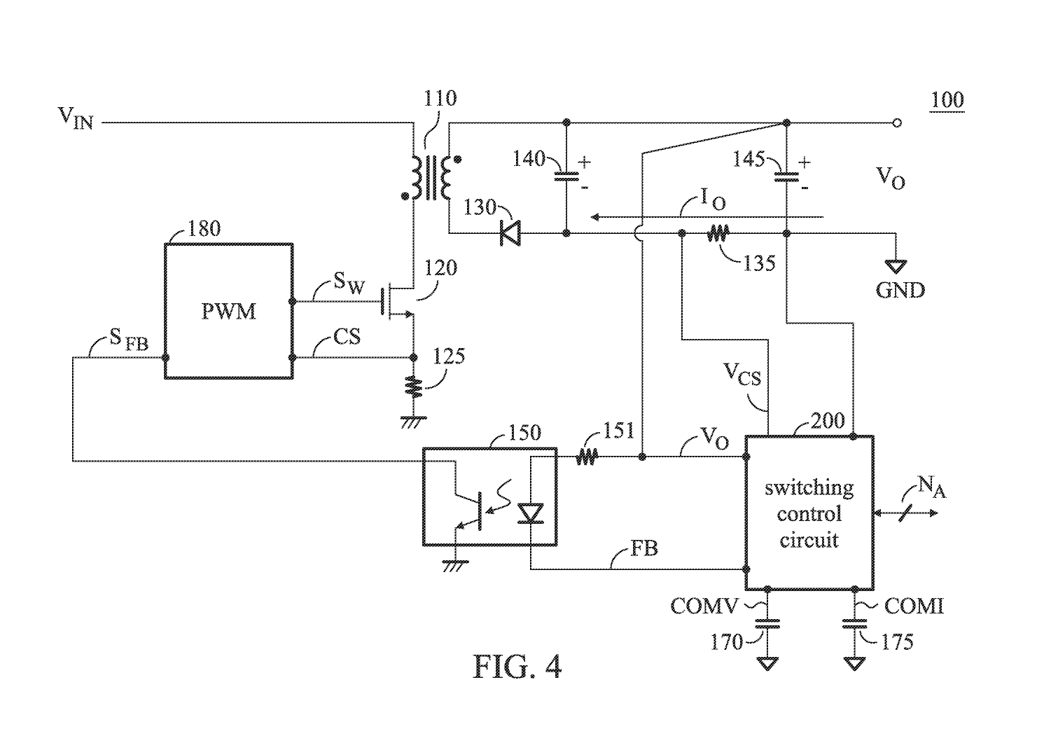

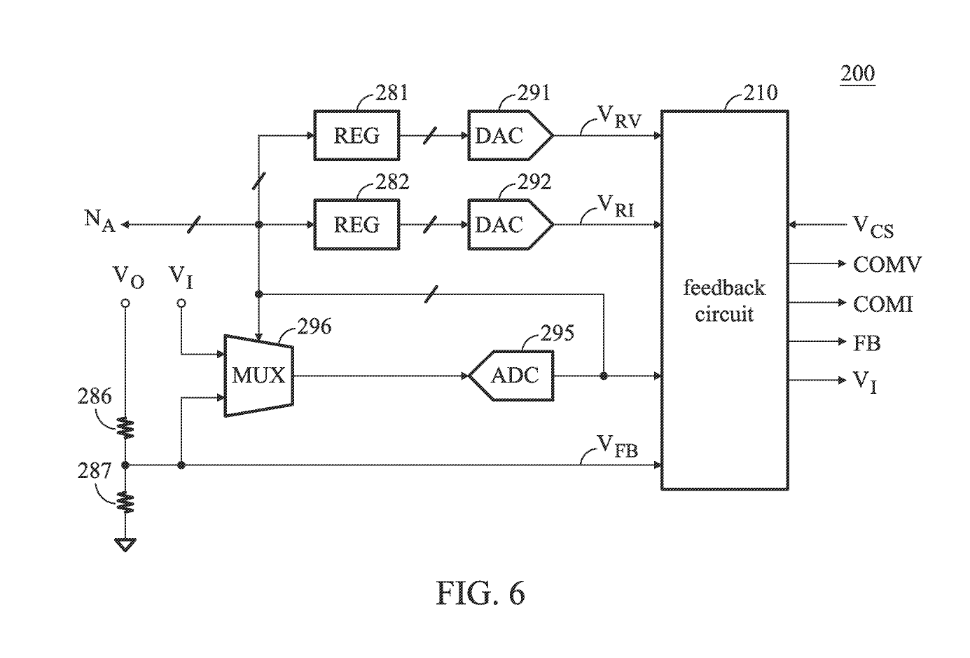

FIG. 4 shows an exemplary embodiment of the programmable power supply circuit 100 in accordance with the present invention. A switching controller (PWM) 180 generates a switching signal S_{W} coupled to switch a transformer 110 through a transistor 120 for generating the output voltage V_{O} and the output current I_{O} in accordance with a feedback signal S_{FB}. A switching control circuit 200 generates a feedback signal FB in response to the output voltage V_{O} (such as the DC voltage of the output voltage V_{O}) and a programmable voltage reference V_{RV} (shown in FIG. 6). The programmable voltage reference V_{RV} is determined by the command-data Dc. Furthermore, the switching control circuit 200 generates the feedback signal FB in response to the output current I_{O} (such as the DC voltage of the output current I_{O}) and a programmable current reference V_{RI}. The programmable current reference V_{RI} is determined by the command-data Dc.

A current-sense device, such as a resistor 135, generates a current-sense signal V_{CS} in accordance with the output current I_{O}. In other words, the power adaptor 10 can detect the output current I_{O} (such as the DC current of the output current I_{O}) through the resistor 135 to generate the current-sense signal V_{CS}. The switching control circuit 200 is coupled to detect the output voltage V_{O} and the current-sense signal V_{CS} for developing the feedback loop and generate the feedback signal FB. The switching control circuit 200 generates the feedback signal FB coupled to the switching controller 180 through an opto-coupler 150 for generating the feedback signal S_{FB} and regulating the output voltage V_{O} and the output current I_{O}. A capacitor 170 is coupled to receive a voltage-feedback signal COMV for the voltage-loop compensation. A capacitor 175 is coupled to receive a current-feedback signal COMI to compensate the current-loop for the regulation of the output current I_{O}. A resistor 151 is utilized to bias an operating current of the opto-coupler 150.

The opto-couplers 150 generates the feedback signal S_{FB} in accordance with the feedback signal FB. The switching controller 180 generates the switching signal S_{W} for switching the primary-side winding of the transformer 110 and generating the output voltage V_{O} and the output current I_{O} at the secondary-side of the transformer 110 through a rectifier 130 and output capacitors 140 and 145. A resistor 125 is coupled to sense the switching current of the transformer 110 for generating a current signal CS coupled to the switching controller 180.

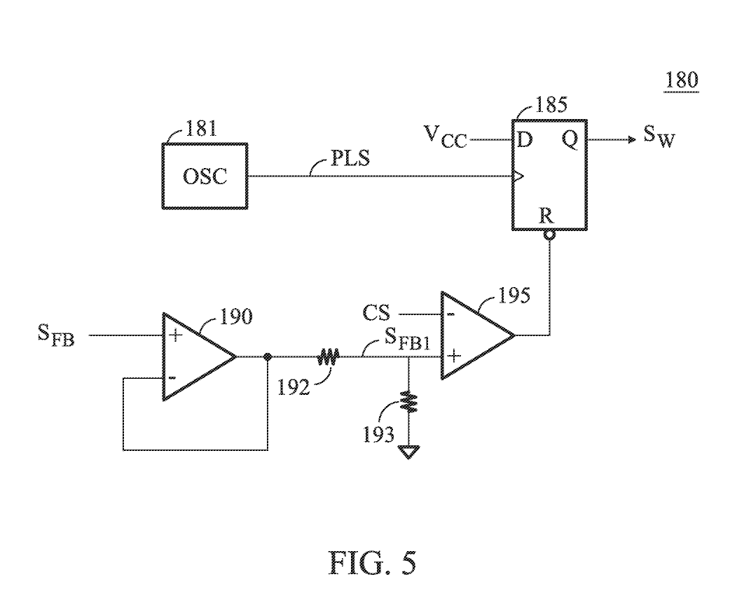

FIG. 5 shows an exemplary embodiment of the switching controller 180. The switching controller 180 comprises an oscillator (OSC) 181 for generating a clock signal PLS. The clock signal PLS is coupled to enable a flip-flop 185 and the switching signal S_{W}. The feedback signal S_{FB} is coupled to compare with the current signal CS through a buffer 190, resistors 192 and 193 and a comparator 195. The buffer 190 and the resistors 192 and 193 generate a level-shifted feedback signal S_{FB1} in accordance with the feedback signal S_{FB}. An input of the comparator 195 receives the current signal CS, and another input thereof receives the level-shifted feedback signal S_{FB1}. For the pulse width modulation (PWM), the comparator 195 is coupled to reset the flip-flop 185 and disable the switching signal S_{W} when the current signal CS is higher than the level-shifted feedback signal S_{FB1}.

FIG. 6 shows an exemplary embodiment of the switching control circuit 200 in accordance with the present invention. The data-bus signal N_{A} is coupled to control a multiplexer (MUX) 296, an analog-to-digital converter (ADC) 295, and digital-to-analog converters (DACs) 291 and 292. In detailed, the digital-to-analog converters 291 and 292 are controlled by the microcontroller 25 of the control circuit 20 (shown in FIG. 3) through receiving the data-bus signal N_{A} and registers (REG) 281 and 282. The current-sense signal V_{CS} is coupled to generate a current signal V_{I} through a feedback circuit 210. The current signal V_{I} is coupled to the multiplexer 296. Resistors 286 and 287 develop a voltage divider for generating a feedback signal V_{FB} in accordance with the output voltage V_{O}. The feedback signal V_{FB} is also coupled to the multiplexer 296. The output of the multiplexer 296 is coupled the analog-to-digital converter 295. Therefore, via the data-bus signal N_{A}, the microcontroller 25 can read and/or detect the information of the output current I_{O} and the output voltage V_{O} (such as the DC current of the output current I_{O} and the DC voltage of the output voltage V_{Ox′}) through the analog-to-digital converter 295. The microcontroller 25 controls the output of the digital-to-analog converters 291 and 292. The digital-to-analog converter 291 generates the programmable voltage reference V_{RV} for controlling the output voltage V_{O}. The digital-to-analog converter 292 generates the programmable current reference V_{RI} for controlling the output current I_{O}. The registers 281 and 282 will be reset to an initial value in response to the power-on of the switching control circuit 200. For example, the initial value of the register 281 will produce a minimum value of the programmable voltage reference V_{RV} that generates a 5V output voltage V_{O}. The initial value of the register 282 will produce a minimum value of the programmable current reference V_{RI} that induces the generation of the output current I_{O} with 0.5 A. The feedback circuit 210 generates the voltage-feedback signal COMV, the current-feedback signal COMI, and the feedback signal FB in response to the programmable voltage reference V_{RV}, the programmable current reference V_{RI}, the feedback signal V_{FB}, and the current-sense signal V_{CS}.

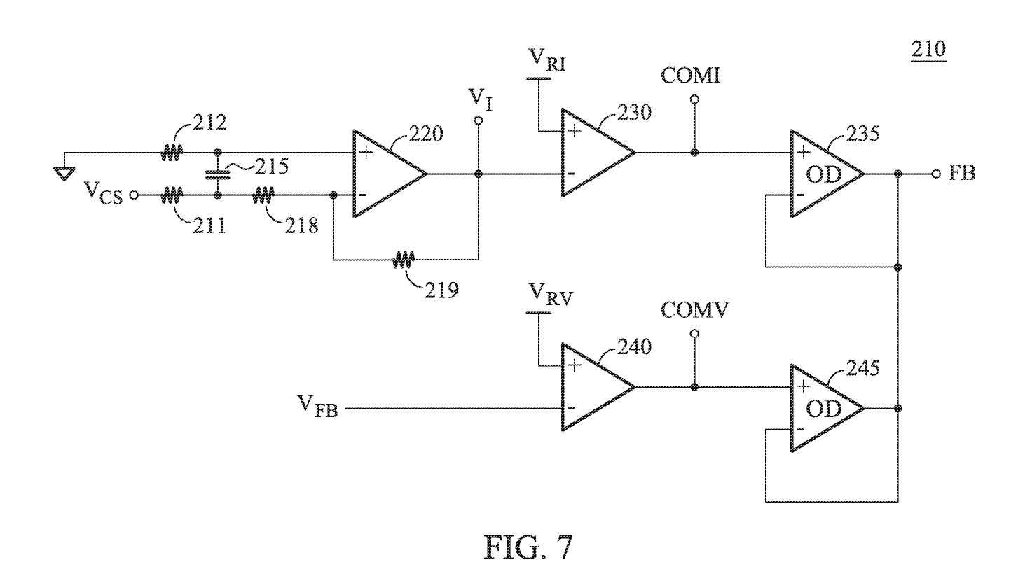

FIG. 7 shows an exemplary embodiment of the feedback circuit 210 in accordance with the present invention. The feedback circuit 210 comprises resistors 211 and 212 and a capacitor 215 coupled to receive the current-sense signal V_{CS} and filter the noise in the current-sense signal V_{CS}. The capacitor 215 is coupled to an operational amplifier 220. Resistors 218 and 219 determine the gain of the operational amplifier 220. The operational amplifier 220 generates the current signal V_{I} by amplifying the current-sense signal V_{CS}. An error amplifier 230 receives the current signal V_{I} and the programmable current reference V_{RI} and generates the current-feedback signal COMI in accordance with the current signal V_{I} and the programmable current reference V_{RI}. The current-feedback signal COMI is coupled to the capacitor 175, shown in FIG. 4, for the current-loop compensation. An error amplifier 240 receives the feedback signal V_{FB} and the programmable voltage reference V_{RV} and generates the voltage-feedback signal COMV in accordance with the feedback signal V_{FB} and the programmable voltage reference V_{RV}. The voltage-feedback signal COMV is coupled to the capacitor 170, shown in FIG. 4, for the voltage-loop compensation. The voltage-feedback signal COMV is further coupled to a buffer (OD) 235 to generate the feedback signal FB. The current-feedback signal COMI is further coupled to a buffer (OD) 245. The output of the buffer 245 is coupled to the output of the buffer 235. The buffer 235 and the buffer 245 have the open-drain output, thus they can be wire-OR connected.

According to the description above, the present invention provides a controller to replace traditional buck converter or a buck/boost converter which takes cause further power loss. The invention achieves higher efficiency and takes less power loss.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An apparatus for charging a battery comprising:
a power adaptor having a communication interface coupled to a cable of the power adapter for receiving command-data, and generating a DC voltage and a DC current in accordance with the command-data; and
a controller, coupled to the battery for detecting a battery voltage of the battery, generating the command-data in accordance with the battery voltage;
wherein the DC voltage and the DC current generated by the power adaptor are coupled to the cable, and the DC voltage and the DC current are programmable in accordance with the command-data; and
wherein the command-data generated by the controller is coupled the cable through a communication circuit of the controller.

2. The apparatus as claimed in claim 1, further comprising:
a switch coupled to the cable for receiving the DC voltage and the DC current through a connector.

3. The apparatus as claimed in claim 2, wherein the controller is coupled to the connector for detecting a connector voltage and controls an on/off state of the switch in response to the connector voltage.

4. The apparatus as claimed in claim 1, wherein the controller has a communication port coupled to a host CPU.

5. The method and apparatus as claimed in claim 1, wherein the power adapter is coupled to an AC power source for generating the DC voltage.

6. The apparatus as claimed in claim 1, wherein the controller comprises an analog-to-digital converter coupled to the battery and the connector for detecting the

7. The apparatus as claimed in claim 1, wherein the controller comprises a microcontroller with a program memory and a data memory.

8. The apparatus as claimed in claim 1, wherein the power adapter comprises an embedded microcontroller with the program memory and the data memory.

9. The apparatus as claimed in claim 1, wherein the power adapter comprises:
a switching controller generating a switching signal coupled to switch a transformer for generating the DC voltage in accordance with a feedback signal; and
a switching control circuit generating the feedback signal in response to the DC voltage and a programmable voltage reference;
wherein the programmable voltage reference is determined by the command-data.

10. The apparatus as claimed in claim 9, wherein the switching control circuit comprises a first digital-to-analog converter for generating the programmable voltage reference.

11. The apparatus as claimed in claim 9, wherein the switching controller generates the switching signal coupled to switch the transformer for further generating the DC current in accordance with the feedback signal, the switching control circuit generates the feedback signal further in response to the DC current and a programmable current reference, and the programmable current reference is determined by the command-data.

12. The apparatus as claimed in claim 11, wherein the switching control circuit comprises a second digital-to-analog converter for generating the programmable current reference.

13. The apparatus as claimed in claim 9, wherein the switching control circuit

14. The apparatus as claimed in claim 9, wherein the switching control circuit comprises an analog-to-digital converter for detecting the DC current.

15. The apparatus as claimed in claim 7, wherein the power adapter comprises a resistor for detecting the DC current.

16. The apparatus as claimed in claim 15, wherein the switching control circuit comprising an amplifier coupled to the resistor for detecting the DC current.

17. The method as claimed in claim 1, wherein the switch will be turned off if the voltage drop of the cable and the connector is high.
